(19) United States
(12) Patent Application Publication
(10) Pub. No.: US 2004/0212193 A1
(43) Pub. Date: Oct. 28, 2004

(54) Connector

(76) Inventor: Ian David Johnstone, Steyning (GB)

Correspondence Address: THE GATES CORPORATION, IP LAW DEPT. 10-A3, 1551 WEWATTA STREET, DENVER, CO, 80202, US

(21) Appl. No.: 10/267,486

(22) Filed: Oct. 8, 2002

(51) Int. Cl. F16L 15/00

(52) U.S. Cl. 285/390

(57) ABSTRACT

A fluid connector comprising a body having bore. Apertures disposed about a portion of the body allow a fluid flow to communicate with the bore. Sealing members on a body surface engage cooperating sealing surfaces on component members to be joined. An end of the body is formed to connect the fluid connector to a component member.

### FIELD OF THE INVENTION

The invention relates to a connector and more particularly to a fluid connector having a fluid conduit and sealing members, the fluid connector for spanning a gap between component parts to be joined.

### BACKGROUND OF THE INVENTION

Assembly of components can be adversely affected by tolerances, that is, dimensional differences between components that may result in gaps between components to be joined. Such gaps cannot always be eliminated, but only allowed for in the assembled device. Tolerances can also “stack” when more than two components are joined at a particular location, creating a significant gap between the components.

Such gaps or tolerances may be very small, fractions of a millimeter, or very large, several millimeters or centimeters, depending upon the circumstances. Larger tolerances generally reduce manufacturing costs, however in such cases it is generally not possible to properly gasket the gap between the components in order to effect a fluid tight connection, particularly in the case of elevated fluid pressures. Further, pressing parts together to reduce or eliminate a gap can result in undesirable stresses being formed in the components.

Representative of the prior art is U.S. Pat. No. 4,171,007 to Bouteille (1979) which discloses a unidirectional flow limiter housed in a union between a pipe and a user apparatus.

The prior art does not solve the problem of compensating for significant gaps between components while simultaneously creating a fluid tight connection without inducing undesirable stresses in the components being joined.

What is needed is a fluid connector that compensates for a gap between components while simultaneously creating a fluid tight connection without inducing undesirable stresses in the components being joined. The present invention meets these needs.

### SUMMARY OF THE INVENTION

The primary aspect of the invention is to provide a fluid connector that compensates for a gap between components while simultaneously creating a fluid tight connection without inducing undesirable stresses in the components being joined.

Other aspects of the invention will be pointed out or made obvious by the following description of the invention and the accompanying drawings.

The invention comprises a fluid connector comprising a body having a bore. Apertures disposed about a portion of the body allow a fluid flow to communicate with the bore. Sealing members on a body surface engage cooperating sealing surfaces on component members to be joined. An end of the body is formed to connect the fluid connector to a component member.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a cross-sectional view of the inventive connector.

FIG. 2 is a cross-sectional view of the inventive connector.

FIG. 3 is an alternative embodiment for portion depicted at (A) in FIG. 2.

### DETAILED DESCRIPTION OF THE PREFERRED EMBODIMENT

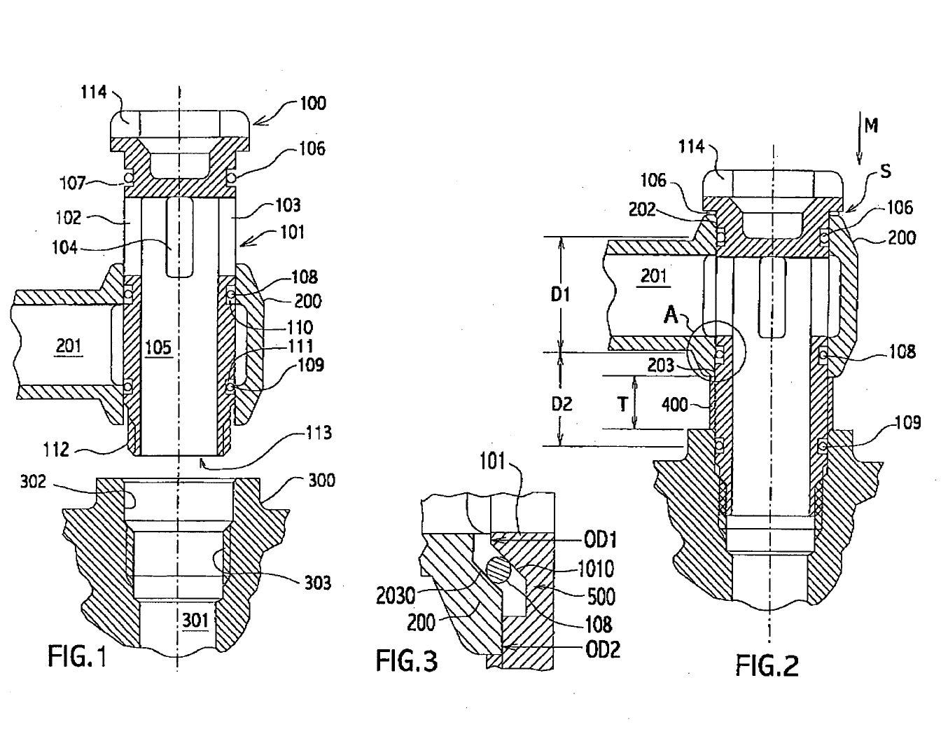

FIG. 1 is a cross-sectional view of the inventive fluid connector. Connector 100 connects a component or member 200 to a component or member 300. By way of example, member 200 may comprise a water pump that is connected to an engine. Member 300 may comprise an engine to which the water pump is attached. In this example one or more of the inventive connectors may be used to attach the water pump to an engine.

Connector 100 comprises a cylindrical body portion 101. Apertures 102, 103, 104 are spaced about a portion of body 101. Apertures 102, 103, 104 allow a fluid flow from a fluid conduit 201 to enter or exit or otherwise communicate with bore 105. A fluid, such as a liquid or gas, flows from conduit 201 through bore 105 and out of opening 113 into fluid conduit 301 in member 300. Any number of apertures may be used, each having a form and size to accommodate a fluid flow as required by a particular application. A size of each aperture may be designed having a predetermined size to act as a flow orifice or orifices in order to control a rate and/or pressure of a fluid flow as may be required by a user.

Connector 100 also comprises sealing members 106, 108 and 109. Sealing member 106 is contained in circumferential receiving portion or groove 107. Sealing member 108 is contained in circumferential receiving portion or groove 110. Sealing member 109 is contained in circumferential receiving portion or groove 111. Sealing member 106 and 108 are cooperatively disposed with respect to apertures 102, 103, 104 in order to effect a fluid tight connection to member 200 and to thereby define a flow path from fluid conduit 201 to bore 105 through apertures 102, 103, 104. Sealing member 109 is cooperatively disposed with respect to member 300 in order to effect a fluid tight connection between connector 100 and member 300 and thereby to fluid conduit 301.

Each of sealing members 106, 108, 109 may comprise a polymeric or elastomeric o-ring type seal, or other gasket as known in the art.

An end of body 101 has helical threads 112. Threads 112 may either be right hand thread or left hand thread. Threads 112 engage cooperating helical threads 303 in member 300 whereby the connector and components are secured.

Connector 100 also comprises flats 114 which allow the connector to be turned by a tool such as a socket wrench, open end wrench, or the like.

The preferred embodiment comprises metallic material such as aluminum or steel or the like. The material should be compatible with the material of the components to be joined. Connector 100 may also comprise a non-metallic material such as plastics, including polypropylene, nylon 6/6, polyphthalamide (PPA), thermoplastic polyester, polyphenylene sulfide, polycarbonate, or a combination of two or more of the foregoing. The non-metallic connector may be fabricated by injection molding. In the non-metallic embodiment, sealing members 106, 108 and 109 may be molded directly into the body of the connector.

The material should tolerate the operating temperature of an engine up to a minimum of approximately 250° F. It should also have sufficient strength to accommodate a working pressure of up to a minimum of approximately 20 psig while providing sufficient structural strength to connect the desired components.

FIG. 2 is a cross-sectional view of the inventive connector. Use of connector 100 allows member 200 to be connected to member 300 while compensating for a tolerance or gap T between the members. This reduces assembly time and cost. Therefore, the gap can be accommodated by the connector as a design feature of the assembly.

Sealing members 106 and 108 are spaced apart by a distance D1. Sealing members 108 and 109 are spaced apart by a distance D2. Member 200 comprises sealing surfaces 202, 203 which are sealingly engaged by sealing members 106 and 108 respectively. Member 300 comprises sealing surface 302 that is sealingly engaged with sealing member 109, see FIG. 1. The location at which the sealing members engage the sealing surfaces can be adjusted depending upon the size of gap T. In an alternate embodiment, sealing surfaces 202 and 203 may also be chamfered in order to provide a surface or face against which sealing members 106 and 108 may engage, see FIG. 3.

In an alternate embodiment an outside diameter of the connector is incrementally decreased, or tapered in a direction parallel to a major axis, from a diameter for a sealing surface for sealing member 106 to a lesser diameter for a sealing surface for sealing member 108 to yet a lesser diameter for a sealing surface for a sealing member 109. More particularly, see FIG. 3.

FIG. 3 is an alternative embodiment for a portion depicted at (A) in FIG. 2. Different outside diameters of surfaces on body 101, namely OD1 and OD2, cooperate with inside diameters of surfaces on member 200 and member 300 to provide a taper to joint 500. Joint 500 comprises an inclined sealing surface 2030 cooperatively disposed with an inclined surface 1010 on body 101. Sealing member 108 is then disposed and captured between surfaces 2030 and 1010 to provide a fluid tight seal. In this alternate embodiment, OD1 is greeter than OD2. For this alternate embodiment, sealing members 106 and 109 and surfaces 202 and 302 have substantially the same tapered arrangement as described for joint 500. More particularly, sealing surfaces 202 and 302, plus cooperating surfaces on members 200 and 300, comprise incrementally decreasing diameters to create an overall tapered form for the connector. The greatest outside diameter joint being disposed with respect to sealing member 106 and the smallest outside diameter joint being disposed with respect to sealing member 109.

To install the connecter, bore 202 in member 200 is aligned with fluid conduit 301 in member 300. Connector 100 is then inserted into bore 202 until helical threads 112 engage helical threads 303. Connector 100 is screwed or threaded into member 300.

Once connector 100 is fully engaged into member 300, each of the sealing members aligns with its respective sealing surface thereby creating a fluid tight seal while compensating for a gap T between member 200 and member 300. More particularly, the inventive connector allows members 200 and 300 to be connected together with a fluid tight connection without the need to have a direct gasketed, fluid tight engagement between member 200 and member 300. Instead, the inventive connector spans the gap T with a fluid tight connection and conduit. This allows the members to be manufactured and assembled with a fluid tight seal and conduit across a gap T without the need for directly engaging one member with the other. This in turn allows timely assembly of fluid conducting components with relatively large tolerances between them that would otherwise not be possible.

Since the inventive connector accomplishes a fluid tight connection by engagement of the sealing members with cooperating sealing surfaces while also compensating for an assembly gap, the connector need not be torqued in place solely to effect a desired fluid seal and tolerance compensation. A connector 100 length may be selected so this it is ‘bottomed’ in member 300 without imposing a moment arm or undesirable stress on member 200. This may result in certain instances in an additional space S between a top of connector 100 and member 200 as shown in FIG. 2.

A support spacer 400 may be disposed between member 200 and member 300. Spacer 400 supports member 200 during connector installation and thereby prevents unnecessary stress on member 200 which may otherwise be realized if connector 100 is tightened against member 200 with member 200 in an otherwise unsupported state. Use of spacer 400 is optional depending upon the particular application. Spacer 400 comprises a suitably rigid material, for example, metal or plastic.

In an alternate embodiment, spacer 400 comprises a material having a damping coefficient, for example, an elastomeric material. In this alternate embodiment, sealing member 106 is fitted in space S, instead of in groove 107, with a predetermined preload, see FIG. 2. Spacer 400 damps a vibration from an engine 300 which might otherwise be transmitted to a water pump member 200. The elastomeric material includes HNBR, PPA, PU, PE, EPDM, or any combination of two or more of the foregoing.

In yet an alternate embodiment, threads 112 and 303 are replaced by cooperating surfaces having an interference fit so that the connector 100 is press fit into bore 301 during assembly.

Although forms of the invention has been described herein, it will be obvious to those skilled in the art that variations may be made in the construction and relation of parts without departing from the spirit and scope of the invention described herein.

1. (Cancelled).

2. (Cancelled).

3. (Cancelled).

4. (Cancelled).

5. (Cancelled).

6. (Cancelled).

7. (Cancelled).

8. (Cancelled).

9. (Cancelled).

10. (Cancelled).

11. A connector for connecting across a gap between a first member and a second member comprising:
a body having a bore;
the body describing an aperture;
a first sealing member disposed on an outer surface of the body;
a second sealing member disposed on the outer surface of the body;
the first sealing member and the second sealing member cooperatively disposed with the aperture and the first member in order to define a flow path from the first member to the bore;
a third sealing member disposed in a groove on the outer surface of the body;
the third sealing member engageable with a second member sealing surface; and
an end of the body having a means for operatively connecting with the second member.

12. The connector as in claim 11, wherein the connecting means comprises a helical thread for engaging a helical thread in the second member.

13. The connector as in claim 11 further comprising a member disposed between the first member and the second member.

14. The connector as in claim 13, wherein the member comprises elastomeric material for damping a vibration.

15. The connector as in claim 11, wherein the body further describes incrementally smaller diameters along a major axis.

16. The connector as in claim 11, wherein the body connects with the second member by a press fit.

17. The connector as in claim 11, wherein the first member comprises an engine water pump and the second member comprises an engine block.

18. A method of assembling a first structural member and second structural member comprising the steps of:
inserting a conduit body into a first structural member bore;
threading the conduit body into a second structural member;
sealing the conduit body with the first structural member to prevent fluid leakage;
disposing a seal in a groove on the conduit body to seal the conduit body to the second structural member; and
spanning a gap (T) between the first structural member and second structural member with the conduit body.

19. The method as in claim 18 further comprising the step of:
disposing a support spacer member between the first structural member and the second structural member whereby only the first structural member is supported by the support spacer member and whereby the support spacer is not clamped to the second structural member by the body.
